(19) United States
(12) Patent Application Publication
(10) Pub. No.: US 2015/0021809 A1
(43) Pub. Date: Jan. 22, 2015

(54) FLASH REMOVAL APPARATUS AND METHOD

(71) Applicant: Jeffrey Schmitz, (US)

(72) Inventor: Jeffrey Schmitz, (US)

(73) Assignee: Met-L-Tec LLC, Temperance, MI (US)

(21) Appl. No.: 13/945,250

(22) Filed: Jul. 18, 2013

(51) Int. Cl. B29C 67/00

(52) U.S. Cl. CPC B29C 67/0044
USPC 264/161; 425/387.1

(57) ABSTRACT

The invention is directed to a method and apparatus for removing flash from molded parts. The method and apparatus is primarily used with molded plastic parts, but parts formed of other material can also be processed with the equipment of the present invention. The parts are held in position by an electroform mask and an electroform mask is utilized to protect the surface of the part adjacent to the flash that is to be removed. A spin jet nozzle is utilized to provide fluid under pressure to the areas of the part where the flash is to be removed.

### CROSS REFERENCE TO RELATED APPLICATIONS

This application claims the benefit of provisional patent application Ser. No. 61/673,906, filed on Jul. 20, 2019.

### BACKGROUND OF THE INVENTION

Molded plastic parts, made from plastics such as bulk molding compound, have become a standard item in most industries. When the parts are molded there is almost always a seam between the pieces of the mold that produces a flash or area of excess material that is undesirable. As the mold must usually be separated to remove the part from the mold it is very difficult to produce a part without some level undesired flash or excess material. The flash is also frequently adjacent to a finished surface on the part so it is important to remove the flash without damaging the finished surface on the part. The removal of the flash from a finished part is more difficult when the part is made from a reinforced plastic such bulk molding compound where it is more difficult to remove the flash.

Prior art methods for removing the flash have involved the use of cutting blades, abrasive devices and high pressure fluids. There has always been a problem with maintaining the part in a desired location so that the flash can be removed from the desired location on the part. Obviously, if the part is not kept in accurate registry with regard to the removal device the flash will not be properly removed from the part. There is also been difficulty with the prior art flash removal tools that the finished surface adjacent to the flash is frequently damaged. This results in either parts that are unacceptable or parts that require additional refinishing before the part can be used for its intended purpose. Both rejected parts and refinishing add substantially to the cost of producing the part. Accordingly, there is a need in the industry for a flash removal method and apparatus that can effectively remove the flash without damaging the other surfaces of the finished part.

### SUMMARY OF THE INVENTION

The invention is directed to a method and apparatus for removing flash from molded parts. The method and apparatus is primarily used with molded plastic parts. The parts are held in position by an electroform mask and an electroform mask is utilized to protect the surface of the part adjacent to the flash that is to be removed. A spin jet nozzle is utilized to provide fluid under pressure to the areas of the part where the flash is to be removed.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a perspective view from the right side of the invention.

FIG. 2 is a perspective view from the left side.

FIG. 3 is a rear elevational view.

FIG. 4 is a front elevational view.

FIG. 5 is a right side elevational view.

FIG. 6 is a left side elevational view.

FIG. 7 is a left side elevational view with the access door closed.

FIG. 8 is a top view of the invention.

FIG. 9 is a perspective view of the clamping device in the open position.

FIG. 10 is a front elevation view of the clamping device.

FIG. 11 is a perspective view of the clamping device in the closed position.

FIG. 12 is an exploded partial front elevational view.

### DETAILED DESCRIPTION OF THE PREFERRED EMBODIMENT(S)

The invention is directed to a method and apparatus for removing flash from molded parts. The method and apparatus is primarily used with molded plastic parts. The parts are held in position by an electroform mask and an electroform mask is utilized to protect the surface of the part adjacent to the flash that is to be removed. A spin jet nozzle is utilized to provide fluid under pressure to the areas of the part where the flash is to be removed. The features of the invention will be more readily understood by referring to the attached drawings in connection with the follow description.

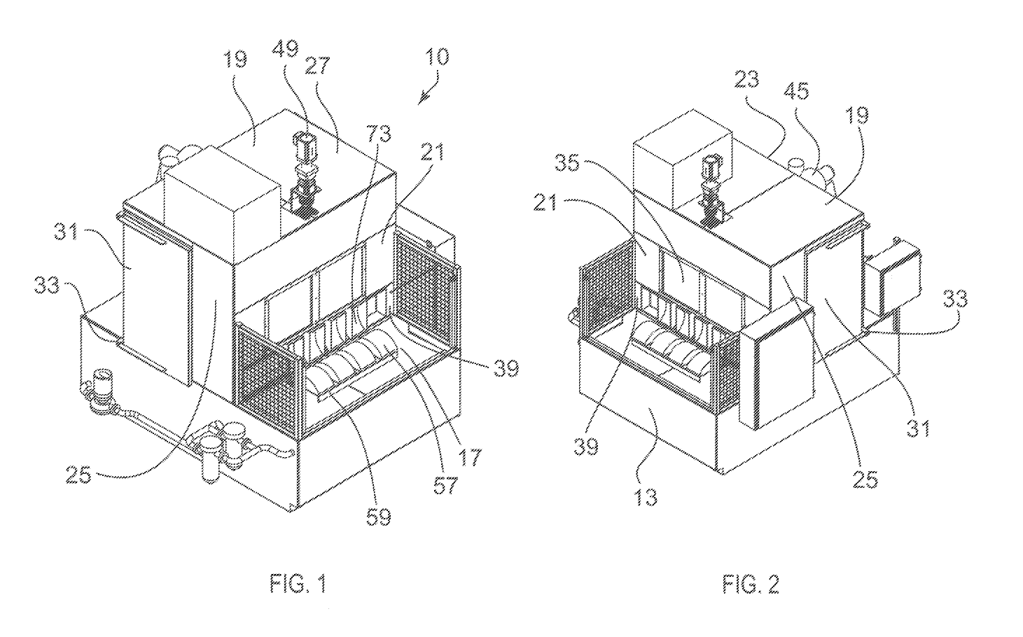

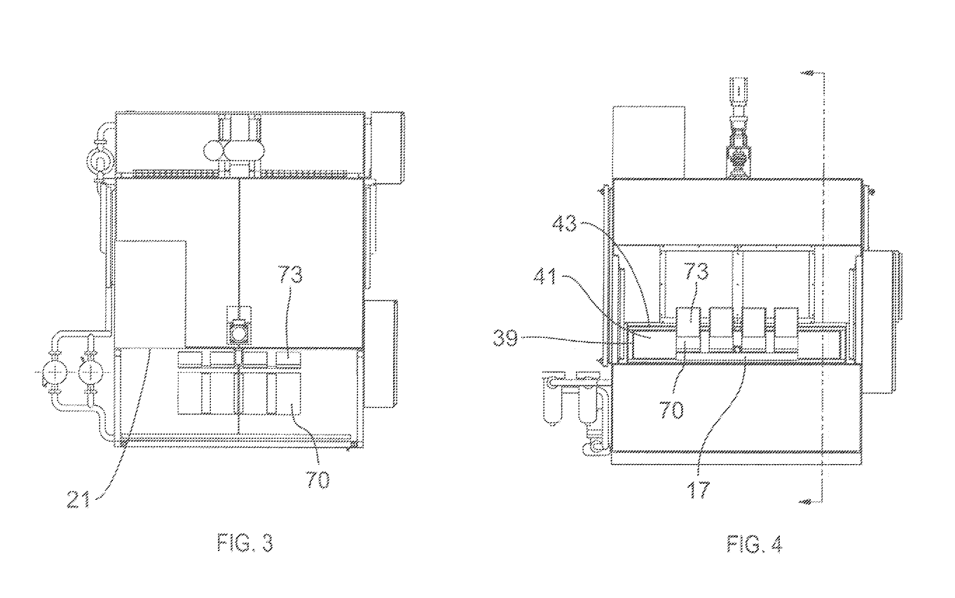

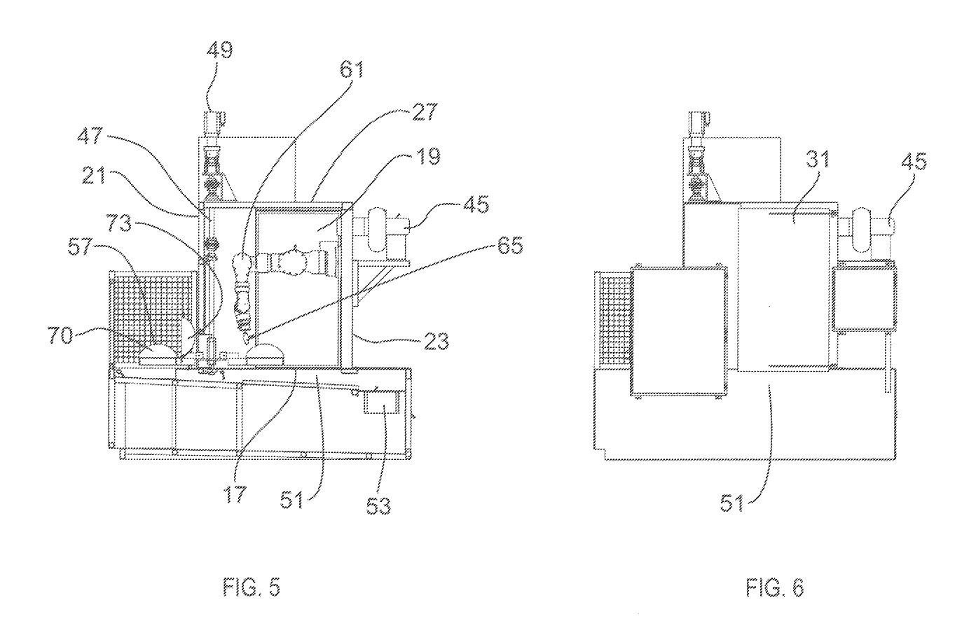

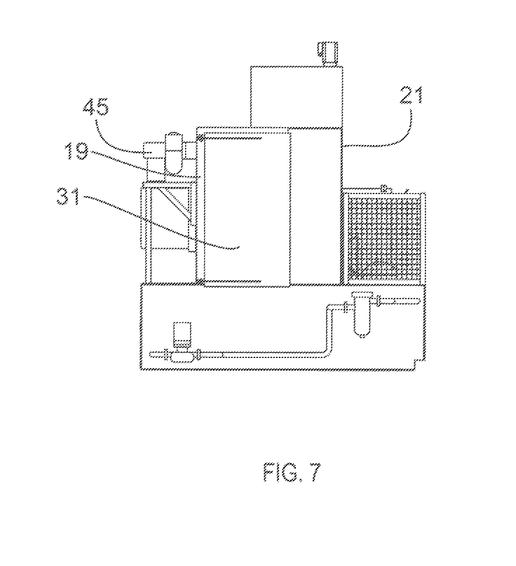

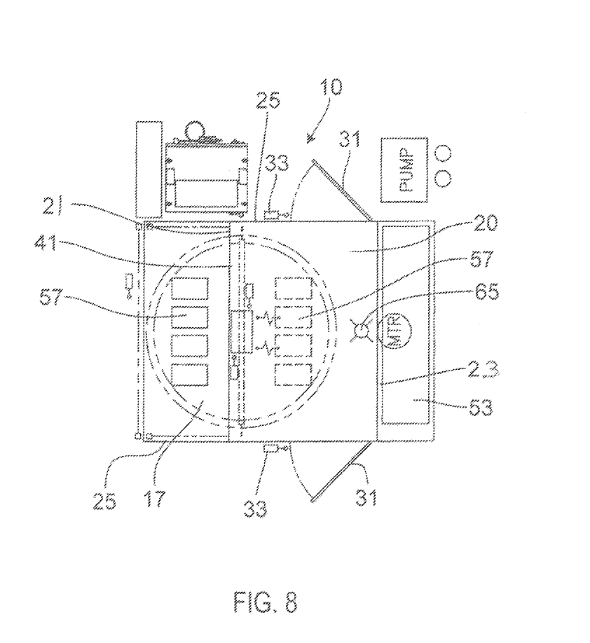

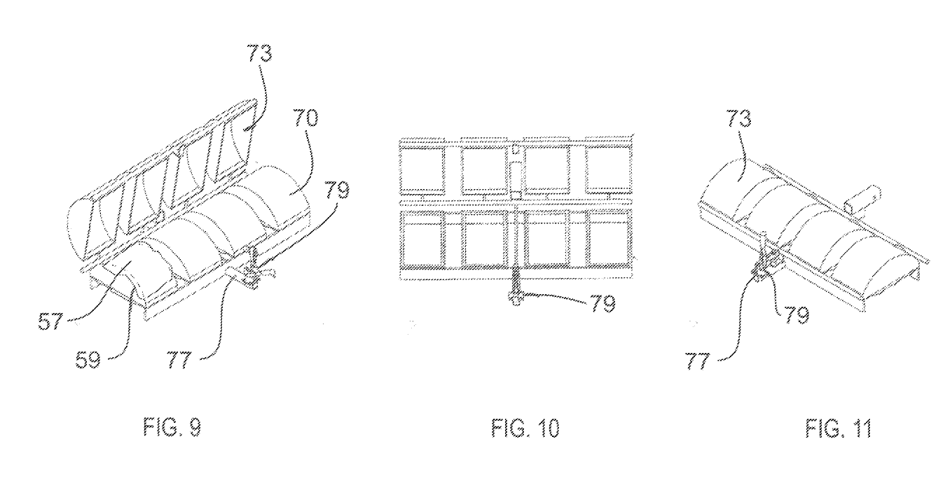

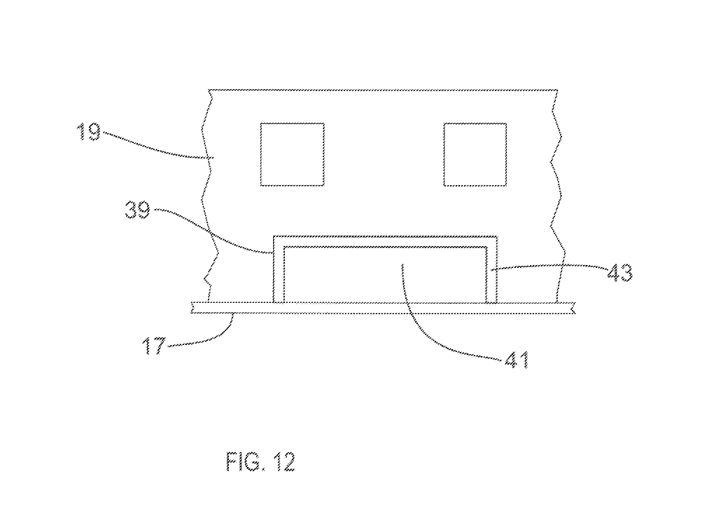

The present invention is particularly well suited to deflash parts made of a bulk molding compound (BMC). The BMC is reinforced with glass fibers and it is important to remove the flash from the part, but at the same time not damage the finish on the remainder of the molded part. The apparatus 10 for removing flash as shown in FIGS. 1-12 has a base 13 upon which a rotatable turn table 17 is rotatably mounted. An enclosure 19 is positioned on the base 13. The enclosure is positioned on the base so that the enclosure extends over substantially one half of the turn table 17. The enclosure has a front wall 21, a rear wall 23 and opposed end walls 25 where the end walls extend between the front wall 21 and the rear wall 23. A top wall 27 is disposed to extend between the front wall 21, rear wall 23, and the two end walls 25. The top wall 27 is disposed to be substantially parallel to the turn table 17. The top wall 27 is also in spaced apart relationship with the turn table 17. A door 31 is positioned on each end wall 25 to provide access to the interior 20 of the enclosure 19. The doors 31 have an interlock switch 33 positioned adjacent each of the doors. An opening 35 is positioned in the rear wall 23 and appropriate safety glass or plastic is positioned in the opening to form a window to provide viewing access to the interior of the enclosure 19. An elongated slot 39 is defined in the rear wall 23 beneath the opening 35. The elongated slot 39 is positioned adjacent the turn table 17. An elongated flange 41 is positioned on the rotatable turn table 17 adjacent to the elongated slot 39 in the rear wall 23 of the enclosure 19. The elongated flange 41 has a width and a height that is substantially the same as the width and height of the elongated slot 39. The elongated flange 41 is designed to rotate through the elongated slot when the turn table 17 is rotated. An elastomeric seal 43 is positioned on the elongated flange 41. The elastomeric seal 43 functions to seal the elongated slot 39 when the turn table is positioned to have the elongated flange 41 in alignment with the elongated slot 39.

A shaft 47 extends from the top wall 27 down along the rear wall 23 to the turn table 17. The shaft 47 is used to rotatably mount the turn table on the base 13. The shaft 47 extends adjacent to the elongated slot 39 and the elongated flange 41. A servo drive or a cam indexer 49 is operatively connected to the shaft for indexing the turn table 17. An exhaust fan 45 can be positioned on the front wall 21. The exhaust fan can be used to withdraw fluids from the interior 20 of the enclosure 19.

A filter basket 51 is positioned adjacent the base 13. The filter basket is disposed adjacent to the front wall 21 of the enclosure 19. The filter basket 51 is positioned slightly below the level of the turn table 17. A second filter 53 is operatively connected to the filter basket 51. The second filter 53 is also operatively connected to a disposal drain and to the fluid input for the apparatus 10.

A plurality of parts 57 having a flash 59 thereon are positioned on the turn table 17 adjacent to the elongated flange 41. The parts 57 are positioned on the portion of the turn table 17 that is outside of the enclosure 19. The parts 57 are positioned on the turn table when the elongated flange 41 is in alignment with the elongated slot 39 in the rear wall 23. Rotation of the turn table 17 will cause the plurality of parts 57 to move into the interior 20 of the enclosure 19. The parts 57 are positioned in the interior of the enclosure 19 with the elongated flange 41 in alignment with the elongated slot 39. A moveable mount 61 is positioned on the front wall 21 of the enclosure 19. A spin jet nozzle 65 is positioned on the moveable mount 61. The spin jet nozzle has a wider spray pattern and does not have to be accurately positioned with respect to the part that is to be deflashed. In addition, lower fluid pressures can be used with the spin jet nozzle and still effectively remove the undesired flash from a part. A source of fluid under pressure is connected to the moveable mount to supply fluid to the spin jet nozzle. The moveable mount 61 is preferably a programmable robot that is capable of positioning the spin jet nozzle in a desired location with respect to the plurality of parts 57 when the parts are in the interior of the enclosure 19.

An electroform mask 70 is positioned on the turn table 17 and forms a supporting base for each of the plurality of parts 57 positioned on the turn table. The electroform mask 70 is designed to cover the interior of the plurality of parts so that the parts are properly supported and positioned on the turn table. The electroform mask 70 substantially conforms to the interior configuration of the parts and provides a very secure base for the parts. The exterior of the parts 57 have a flash 59 that is formed as part of the molding process for the parts. The flash 59 is an undesirable feature that needs to be removed before the parts can be utilized in a finished application. A protective electroform mask 73 is formed on the exterior of the parts 57 and cover the area of the parts adjacent to the flash 59. The protective electroform mask 73 does, however, allow the flash area of the part to be exposed. A clamping device 77 is provided on the turn table 17 for removeably clamping the parts to a fixed positioned on the turn table. The clamping device can be designed so that it engages the electroform mask 70 or the protective electroform mask 73 on the parts 57. As shown in the drawing the protective electroform mask 73 is pivotally positioned with respect to the part 57. The protective electroform mask can be pivoted to place this protective mask in position on the part 57 so that the flash 59 can be effectively removed by the fluid discharged from the spin at nozzle. The clamping device has a clamp mechanism 79 that is designed to securely, but releasably, hold the parts on the turn table 17.

In operation, the parts 57 are positioned on the turn table 17 on a portion of the turn table that is adjacent to the enclosure 19. The parts are positioned on this portion of the turn table on an orientation that is substantially parallel to the elongated flange 41. The parts have the electroform mask 70 that is used to position the parts on the turn table and the protective electroform mask 73 on the exterior of the parts adjacent to the flash 59. The clamping device 77 can be utilized to secure the parts 57 in this location on the turn table. When the parts are properly positioned on the turn table the turn table is rotated to move the parts into the interior of the enclosure 19. The parts are positioned in the interior of the enclosure 19 with parts substantiality parallel to the elongated flange 41. In this orientation the elongated flange 41 is in alignment with the elongated slot 39. The elastomeric seal 43 on the elongated flange 41 thereby effectively closes the elongated slot 39. The position of the parts 57 in the interior of the enclosure 19 can be viewed through the opening 35. In addition, the position of the parts 57, the moveable mounts 61 and spin jet nozzle 65 can be viewed through the doors 31 on the end walls 25 of the enclosure 19.

When the parts are properly positioned in the interior of the enclosure 19 and the doors 31 are properly closed and secured, as determined by the interlock switch 33, fluid can be supplied to the spin jet nozzle 65. The fluid is discharged or ejected from the spin jet nozzle at a pressure from about 2000 psi to about 10,000 psi and this fluid pressure is sufficient to remove the flash 59 from the parts 57. In particular it has been found that a pressure of about 4,000 psi to about 6,000 work particularly well for the fluid that is discharged from the spin jet nozzle. The moveable mount or robotic arm 61 is programmed to direct the spin jet nozzle around the plurality of parts 57 to effectively remove flash 59 from each of the parts. The fluid that is supplied to the spin jet nozzle 65 is usually water as water is very effective for removing plastic flash from parts. The protective electroform mask 73 on the exterior surface of the parts adjacent to the flash 59 protects finished areas of the part being contacted by the fluid from the spin jet nozzle 65. Accordingly, only the material that is intended to be removed is removed from the parts 57. In addition, the protective electroform mask prevents or significantly reduces any potential damage to areas of the part adjacent to the flash 59.

The water from the spin jet nozzle is retained in the interior of the enclosure 19 during the application of the water by the spin jet nozzle 65. The upper surface of the base 13, immediately below the turn table 17 is positioned at an angle whereby the fluid from the spin jet nozzle is directed to the filter basket 51 adjacent to the base 13. The filter basket is utilized to remove the pieces of the flash that are removed by the fluid ejected from the spin jet nozzle. The fluid that is collected from the enclosure 19 passes into the filter basket wherein filters remove the pieces of flash that have been removed from the parts 57. The fluid in the filter basket is then directed to the second filter 53 where smaller particles of flash are removed from the fluid. The fluid that exits from the second filter 53 can either be recycled to the spin jet nozzle or it can be disposed in a regular sewer drain. The filter basket and the second filter remove enough of the flash particles that the fluid is sufficiently clean for disposal or reuse.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. Apparatus for removing flash from a part comprising:
a turntable upon which part to be deflashed are positioned;
an electroform mask positioned on the turntable to hold the part in a desired location on the turntable;
a second electroform mask positioned on the part to screen areas of the part adjacent to the flash to be removed;
a spin jet nozzle disposed adjacent the turntable, the spin jet nozzle being disposed to direct a stream of fluid at the area of the part where the flash to be removed is located.

2. The apparatus of claim 1 wherein the electroform mask and the second electroform mask are nickel based masks.

3. The apparatus of claim 1 wherein the spin jet nozzle dispenses fluid at a pressure from about 4,000 psi to about 6,000 psi.

4. The apparatus of claim 3 wherein the fluid dispensed by the spin jet nozzle is water.

5. The apparatus of claim 4 wherein the spin jet nozzle does not remove material from the second electroform mask positioned on the part adjacent the flash.

6. The apparatus of claim 1 wherein the turntable is moveable between a loading-unloading zone and a flash removal zone.

7. The apparatus of claim 6 wherein the spin jet nozzle is located in the flash removal zone.

8. The apparatus of claim 1 wherein the spin jet nozzle is positioned on a moveable mount wherein the spin jet nozzle can be moved with respect to the product to effectively remove the flash.

9. The apparatus of claim 8 wherein the movable mount is the arm of a robot.

10. The apparatus of claim 1 wherein an enclosure is positioned over a portion of the turntable, the enclosure retaining the fluid from the spin jet nozzle adjacent the part.

11. The apparatus of claim 10 wherein the enclosure has an elongated slot, the elongated slot being positioned to allow the part to be moved into the enclosure by the rotation of the turntable.

12. The apparatus of claim 11 wherein a flange is positioned on the turntable to close the elongated slot when the part is in the interior of the enclosure.

13. The apparatus of claim 11 wherein a filter basket is positioned adjacent the turntable, the filter basket being disposed to collect the fluid discharged from the spin jet nozzle, the filter basket being designed to remove flash material from the fluid.

14. The apparatus of claim 13 wherein the filter basket is operatively connected to a fluid input for the spin jet nozzle.

15. The apparatus of claim 14 wherein a second filter is operatively connected to the filter basket, the second filter being disposed to remove additional flash material from the fluid.

16. A method for removing flash from a part comprising:
placing the part on an electroform mask positioned on a rotatable turntable;
placing a second electroform mask over the part, the second electroform mask being designed to cover areas of the part adjacent to the flash to be removed; and
directing a stream of fluid from a spin jet nozzle at the area of the part where the flash is to be removed.

17. The method of claim 16 in which the part is located in an enclosure when the stream of fluid is directed at the part.

18. The method of claim 17 in which the part is advanted to the enclosure by the rotation of a turntable upon which the part is positioned.

19. The method of claim 18 in which an elongated opening in the enclosure is closed by a flange positioned on the turntable, the elongated opening being designed to allow the part to move into the enclosure.

20. The method of claim 19 in which the turntable is rotated between a loading-unloading position and a flash removal position.

21. The method of claim 16 in which the spin jet nozzle is moved relative to the part by a moveable mount.

22. The method of claim 16 in which the stream of fluid is directed at the part by the spin jet nozzle at a pressure from about 4,000 psi to about 6,000 psi.
